(19) United States
(12) Patent Application Publication
(10) Pub. No.: US 2025/0285535 A1
(43) Pub. Date: Sep. 11, 2025

(54) SERVER

(71) Applicant: TOYOTA JIDOSHA KABUSHIKI KAISHA, Toyota-shi (JP)

(72) Inventors: Toshiki SHINOHARA, Toyota-shi (JP); Masataka Okuka, Toyota-shi (JP); Kaoru Yoshida, Nisshin-shi (JP); Masatoshi Kakutani, Miyoshi-shi (JP); Kanade Kuriyama, Toyota-shi (JP)

(73) Assignee: TOYOTA JIDOSHA KABUSHIKI KAISHA, Toyota-shi (JP)

(21) Appl. No.: 19/019,941

(22) Filed: Jan. 14, 2025

(30) Foreign Application Priority Data
Mar. 11, 2024 (JP) 2024-036746

(51) Int. Cl. G08G 1/08; G08G 1/017

(52) U.S. Cl. CPC G08G 1/08; G08G 1/017

(57) ABSTRACT

The server refers to the predicted moving body information to identify the first group and the second group. The server calculates the influence degree for each group. The server calculates a display state of the traffic rule display device in which the highly influence degree group among the first group and the second group can continue traveling. The server transmits the calculated request to be in the display state.

### CROSS-REFERENCE TO RELATED APPLICATION

This application claims priority to Japanese Patent Application No. 2024-036746 filed on Mar. 11, 2024, incorporated herein by reference in its entirety.

### BACKGROUND

### 1. Technical Field

The disclosure relates to a server.

### 2. Description of Related Art

Japanese Unexamined Patent Application Publication No. 2017-167669 (JP 2017-167669 A) describes a communication system including a vehicle and a server. When a plurality of vehicles travels as a group, the server transmits a control signal to the vehicles traveling in the group.

### SUMMARY

Now, in a traffic network including a plurality of vehicles, a plurality of groups may pass by a traffic rule display device such as a traffic signal. In a traffic network including a communication system as described in JP 2017-167669 A, there is room for improving efficiency of the traffic network as a whole.

To solve the above problems, the disclosure is a server that transmits a control signal based on predicted moving body information, that is generated based on moving body information that is information of a vehicle in a real world, following a point in time of acquiring the moving body information, to a traffic rule display device that displays different traffic rules by changing a display state, the server executing identifying a first group, and a second group different from the first group, as groups in which a plurality of the vehicles travels in a group, based on the predicted moving body information, calculating, for each of the groups identified, an influence degree, indicating a degree of influence imparted on a traffic network when the group that is an object of calculation is stopped, calculating, when the first group and the second group are located within a vicinity range including a range of traveling in accordance with a display of the traffic rule display device, the display state under which the group of the first group and the second group of which the influence degree is higher can continue traveling, and transmitting a request, that is the display state that is calculated, to the traffic rule display device.

The server transmits the request to the traffic rule display device, thereby enabling a group, of which the influence degree is high among the first group and the second group, to continue traveling. Thus, the server can suppress influence imparted on the traffic network due to the group having a high influence degree stopping.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a communication system;

FIG. 2 is a flowchart illustrating a series of processes for generating predicted moving body information;

FIG. 3 is a flowchart illustrating a series of processes for determining a group;

FIG. 4 is a flow chart showing a series of processes for calculating the influence degree; and

FIG. 5 is a flowchart illustrating a series of processes for transmitting a request to a traffic rule display device.

### DETAILED DESCRIPTION OF EMBODIMENTS

### Embodiment

Hereinafter, an embodiment of a server will be described with reference to the drawings. Hereinafter, a communication system including a server will be described.

### Outline of the Communication System

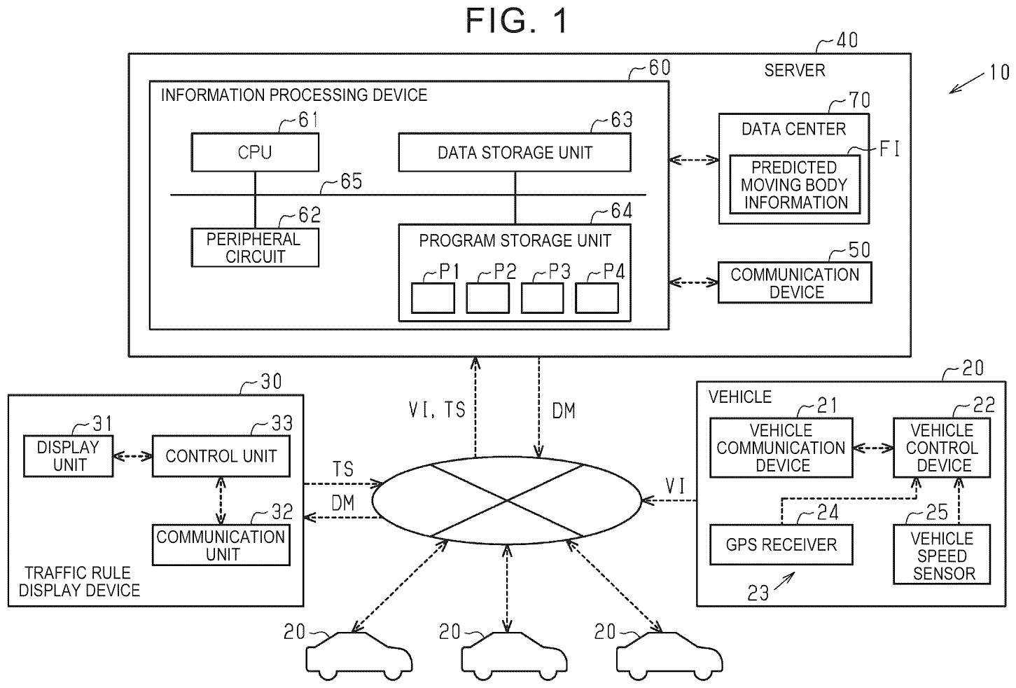

As illustrated in FIG. 1, the communication system 10 includes a plurality of vehicles 20, a traffic rule display device 30, and a server 40.

The vehicle 20 includes a vehicle communication device 21, a vehicle control device 22, and a plurality of information acquisition devices 23. The vehicle communication device 21 communicates with the server 40 by wireless communication. The vehicle control device 22 controls communication of the vehicle communication device 21.

The plurality of information acquisition devices 23 acquire various types of information of the vehicle 20. The plurality of information acquisition devices 23 are, for example, a GPS receiving device 24 and a vehicle speed sensor 25. GPS receiving device 24 receives position data indicating the position of the vehicles 20 from GPS device. The position information is a coordinate value of latitude and longitude. The vehicle speed sensor 25 acquires the traveling speed of the vehicle 20 as the vehicle speed. Each information acquisition device 23 outputs the acquired information of the vehicle 20 to the vehicle control device 22.

The vehicle control device 22 controls the following travel of the vehicle 20. The vehicle control device 22 controls, by a user's operation, the following travel that follows the other vehicle 20 traveling in front. The vehicle control device 22 generates a follow-up information FD indicating that the vehicle is in follow-up travel when the vehicle is in follow-up travel.

The vehicle control device 22 acquires, as the moving body information VI, various kinds of information of the vehicle 20 acquired from the plurality of information acquisition devices 23, identification information indicating the vehicle 20, a point in time at which the various kinds of information are acquired, and a follow-up information FD of the vehicle 20. The moving body information VI is information of the real-world vehicles 20. The identification information indicating the vehicle 20 includes information indicating whether or not the vehicle 20 is in the large-sized vehicle LV and whether or not the vehicle is in the emergency vehicle EV. The large-sized vehicle LV is a vehicle 20 having a total weight of a predetermined weight or more, or a vehicle 20 having a number of persons or more determined in advance by the occupant capacity. Large-sized vehicles LV are large trucks, route buses, and the like. The emergency vehicle EV is, for example, an ambulance.

The vehicle control device 22 outputs the moving body information VI to the vehicle communication device 21. Then, the vehicle communication device 21 transmits the moving body information VI to the servers 40. In FIG. 1, one vehicle 20 of the plurality of vehicles 20 is illustrated in detail, and the other vehicle 20 is illustrated in detail without detail. The vehicles 20 each transmit a moving body information VI to the servers 40.

The traffic rule display device 30 displays a traffic rule. The traffic rule display device 30 can display different traffic rules by changing the display state. The traffic rule display device 30 is, for example, a traffic signal provided at a cross-shaped intersection.

The traffic rule display device 30 includes a display unit 31, a communication unit 32, and a control unit 33. The display unit 31 includes a plurality of lamps. The plurality of lamps includes a red lamp indicating that entry is prohibited at an intersection of a range traveling in accordance with the display of the traffic rule display device 30, and a blue lamp indicating that entry is possible at the intersection.

The communication unit 32 communicates with the server 40 by wireless communication. The communication unit 32 transmits a signal indicating the display state of the display unit 31 to the server 40. The communication unit 32 receives a signal for controlling the display unit 31 from the server 40.

The control unit 33 controls the display state of the display unit 31. For example, the control unit 33 controls a state in which the red lamp is not turned on and the blue lamp is turned on. Further, the control unit 33 controls the display state of the display unit 31 based on a signal for controlling the display unit 31 received by the communication unit 32. The control unit 33 acquires information indicating the display state of the display unit 31, identification information indicating the traffic rule display device 30, and information indicating the point in time in the display state as traffic signal information TS. Then, the control unit 33 outputs the traffic signal information TS to the communication unit 32. The communication unit 32 then transmits the traffic signal information TS to the servers 40.

The server 40 is capable of communicating with a plurality of vehicles 20. In addition, the server 40 can communicate with the traffic rule display device 30. The servers 40 acquire the plurality of moving body information VI from the plurality of vehicles 20. The servers 40 acquire the traffic signal information TS from the traffic rule display device 30. The server 40 can transmit a control signal based on the predicted moving body information FI generated based on the moving body information VI, which will be described later, to the traffic rule display device 30. The server 40 includes a communication device 50, an information processing device 60, and a data center 70.

The communication device 50 communicates with a plurality of vehicles 20. The communication device 50 receives the moving body information VI transmitted from the vehicles 20. The communication device 50 receives the traffic signal information TS transmitted from the traffic rule display device 30. The communication device 50 outputs the received moving body information VI and the received traffic signal information TS to the information processing device 60. Further, the communication device 50 transmits the information acquired from the information processing device 60 to the vehicle 20. The communication device 50 transmits the signal acquired from the information processing device 60 to the traffic rule display device 30.

The information processing device 60 includes a CPU 61 as an executing device, peripheral circuit 62, a data storage unit 63, a program storage unit 64, and a bus 65. The bus 65 communicatively connects CPU 61, the peripheral circuit 62, the data-storage unit 63, and the program-storage unit 64 to each other. The peripheral circuit 62 includes a circuit that generates a clock signal that defines an internal operation, a power supply circuit, a reset circuit, and the like. The data storage unit 63 stores data generated in association with the operation of CPU 61. The program storage unit 64 stores a generation program P1 of the predicted moving body information FI, a determination program P2 of the group GR, a calculation program P3 of the influence degree IF, and a control program P4 of the traffic rule display device 30. CPU 61 performs information processing by executing various programs stored in the program storage unit 64.

The data center 70 stores the predicted moving body information FI. The predicted moving body information FI is information including a plurality of moving body information VI generated based on the moving body information VI of the plurality of vehicles 20 and after the point in time when the moving body information VI in the predetermined area is acquired. The predetermined area may be, for example, a range including one country, a range including only a part of a country, or a range including the last time. That is, the predicted moving body information FI is a so-called digital twin. Specifically, the data center 70 stores time-series data of the predicted moving body information FI generated by the information processing device 60. The data center 70 acquires the predicted moving body information FI generated by the information processing device 60 a plurality of times over time. As a result, the data center 70 stores the time-series data of the predicted moving body information FI.

### Generation of Predicted Moving Body Information

Next, generation of the predicted moving body information FI performed by the information processing device 60 will be described.

CPU 61 repeatedly generates the predicted moving body information FI by repeating the generation program P1 of the predicted moving body information FI at a predetermined cycle. The predetermined period is defined as, for example, one minute.

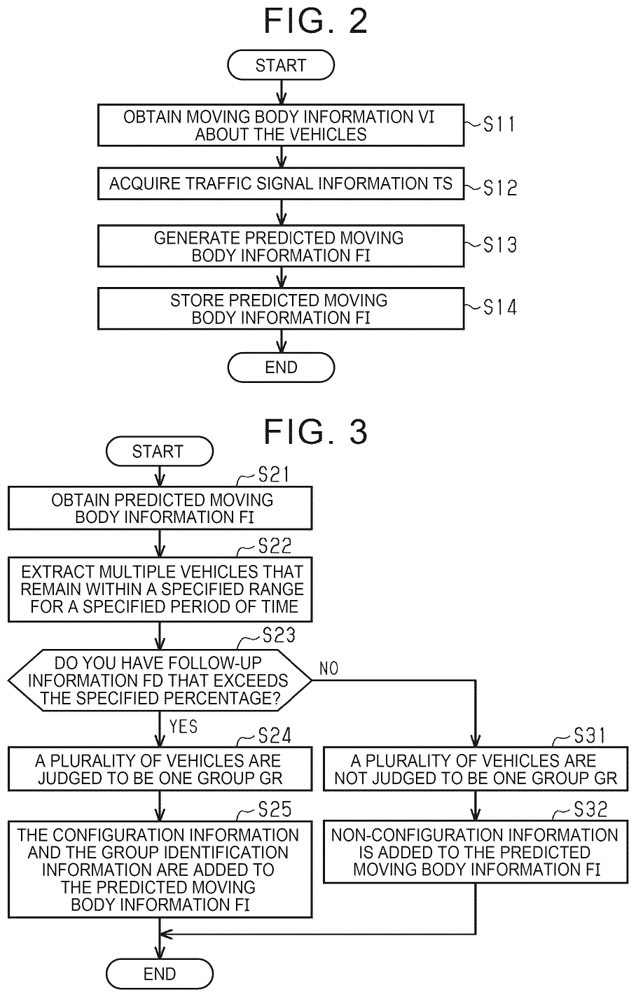

As illustrated in FIG. 2, when CPU 61 starts executing the program P1 for generating the predicted moving body information FI, it first performs a S11 process. In S11, CPU 61 acquires moving body information VI of the vehicles 20 in the communication system 10. When acquiring the plurality of pieces of moving body information VI, CPU 61 acquires the moving body information VI of the respective vehicles 20 based on the identification information of the vehicles 20 included in the moving body information VI. Thereafter, CPU 61 advances the process to S12.

In S12, CPU 61 obtains the traffic signal information TS of the traffic rule display device 30. Thereafter, CPU 61 advances the process to S13.

In S13, CPU 61 generates the predicted moving body information FI based on the plurality of acquired moving body information VI and the traffic signal information TS. Specifically, CPU 61 synchronizes the moving body information VI and the traffic signal information TS of the respective vehicles 20 by performing the following processes, so that CPU 61 generates the predicted moving body information FI. First, CPU 61 refers to information indicating the acquired point in time for the plurality of acquired moving body information VI. Next, CPU 61 predicts the moving body information VI at the reference point in time by correcting the other moving body information VI by the difference of the point in times using the point in time of the moving body information VI having the newest acquired point in time as the reference point in time. For example, CPU 61 is corrected based on a moving body information VI such as a previous vehicle speed. Next, CPU 61 predicts the display status of the traffic rule display device 30 at the reference point in time based on the acquired traffic signal information TS.

Then, CPU 61 generates various types of information of the predicted moving body information VI and the display status of the predicted traffic signal information TS as the predicted moving body information FI. As a result, CPU 61 acquires the moving body information VI and the traffic signal information TS of the plurality of vehicles 20 synchronized with the reference point in time as the predicted moving body information FI. Thereafter, CPU 61 advances the process to S14.

In S14, CPU 61 stores the generated predicted moving body information FI in the data center 70. Thereafter, CPU 61 ends the series of processes. Accordingly, the data center 70 stores the acquired predicted moving body information FI. The data center 70 acquires and stores the predicted moving body information FI at predetermined intervals by CPU 61 repeating the generation program P1 of the predicted moving body information FI. Therefore, the data center 70 stores the time-series data of the predicted moving body information FI.

### Judgment of the Group

Next, the determination of the group GR of the group traveling performed by the information processing device 60 will be described.

CPU 61 repeats the determination-program P2 of the group GR at a predetermined cycle. The predetermined period is defined as, for example, one minute. Accordingly, CPU 61 determines the vehicle 20 constituting the group GR and the vehicle 20 not constituting the group GR among the plurality of vehicles 20 in the predetermined area.

As shown in FIG. 3, when CPU 61 starts executing P2 of the determination program of the group GR, it starts S21 process. In S21, CPU 61 acquires data of the time-series data of the predicted moving body information FI in the data center 70 for a predetermined time period. The past predetermined period is, for example, 10 minutes. Thereafter, CPU 61 advances the process to S22.

In S22, CPU 61 extracts a plurality of vehicles 20 that continue to exist within a predetermined range for a predetermined period in the past, based on the time-series data of the predicted moving body information FI acquired by S21 for a predetermined period in the past. The specified range is, for example, a range in which the distance between the plurality of vehicles 20 is within 100 meters. Thereafter, CPU 61 advances the process to S23. In S22, when CPU 61 cannot extract the plurality of vehicles 20, CPU 61 adds non-configuration information indicating that the group GR is not configured to the predicted moving body information FI for all the vehicles 20, and ends the series of processes.

In S23, CPU 61 determines whether or not the number of vehicles 20 having a specified ratio or more among the plurality of vehicles 20 extracted by S22 is following. For example, the specified ratio is set at 80%. Specifically, CPU 61 determines whether or not the follow-up information FD is included in the moving body information VI of the plurality of vehicles 20 extracted by S22. Then, CPU 61 compares the number of moving body information VI including the follow-up information FD with the number extracted by S22.

When the follow-up information FD is equal to or larger than the specified ratio (S23: YES), CPU 61 advances the process to S24. In S24, CPU 61 determines the plurality of vehicles 20 extracted by S22 as a group GR traveling in one group. Thereafter, CPU 61 advances the process to S25.

In S25, CPU 61 adds configuration information indicating that the group GR is configured and group identification information identifying the configured group GR to the predicted moving body information FI for the plurality of vehicles 20 determined to be one group GR in S24. Thereafter, CPU 61 ends the series of processes.

On the other hand, when the follow-up information FD is not equal to or larger than the specified ratio (S23: YES), CPU 61 advances the process to S31. In S31, CPU 61 does not determine the plurality of vehicles 20 extracted by S22 as one group. Thereafter, CPU 61 advances the process to S32.

In S32, CPU 61 adds, to the predicted moving body information FI, non-configuration information indicating that the group GR is not configured for the plurality of vehicles 20 that have not been determined to be one group GR in S31. Thereafter, CPU 61 ends the series of processes. In this way, the group GR determination program P2 is executed so that the predicted moving body information FI includes information indicating whether or not the group GR is configured.

### Calculation of Influence Degree

Next, the calculation of the influence degree IF of the group GR performed by the information processing device 60 will be described.

CPU 61 repeats the calculation program P3 of the influence degree IF at a predetermined cycle. The predetermined period is defined as, for example, one minute. The influence degree IF indicates a degree of influence on the traffic network in a predetermined area when the group GR to be calculated is stopped. Thus, CPU 61 calculates the influence degree IF for each group GR configured in a predetermined area.

Specifically, CPU 61 refers to the predicted moving body information FI and identifies a second group GR2 that differs from the first group GR1 and the first group GR1 among the plurality of group GR. Specifically, CPU 61 identifies the first group GR1 and the second group GR2 by referring to the information identifying the group GR included in the predicted moving body information FI. CPU 61 calculates the influence degree IF of the first group GR1 and the influence degree IF of the second group GR2, respectively.

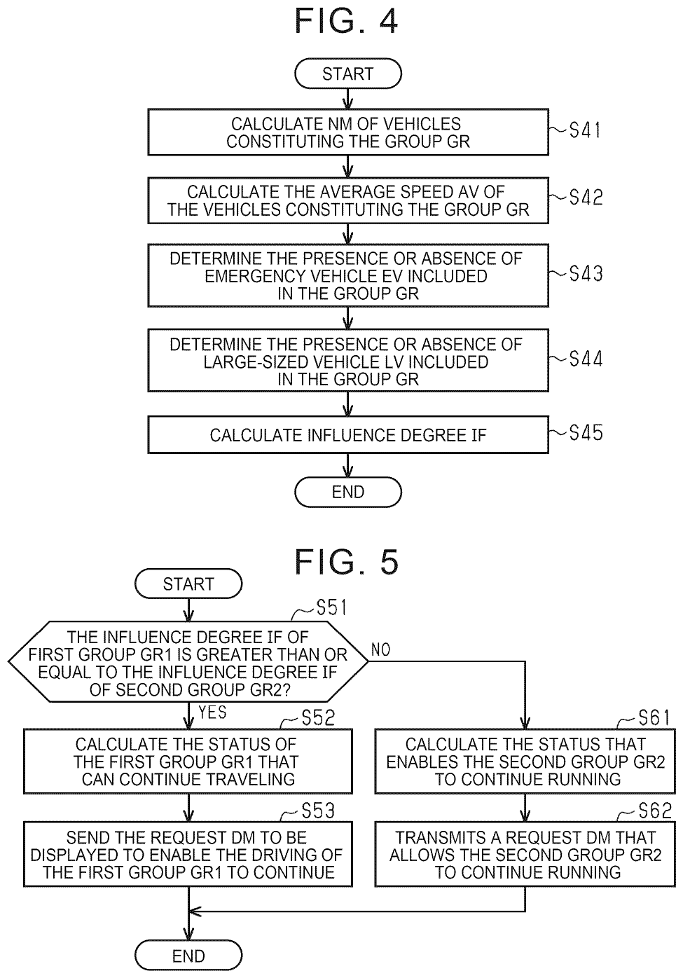

As illustrated in FIG. 4, CPU 61 starts executing the calculation program P3 of the influence degree IF, and CPU 61 first starts S41 process. In S41, CPU 61 calculates several NM of the vehicles 20 constituting the group GR to be calculated. Specifically, CPU 61 refers to the predicted moving body information FI and calculates NM of the vehicles 20 having the information for identifying the group GR to be calculated. Thereafter, CPU 61 advances the process to S42.

In S42, CPU 61 calculates the average speed AV of the vehicles 20 included in the group GR. Specifically, CPU 61 acquires the velocity of the vehicle 20 having the information for identifying the group GR to be calculated by referring to the predicted moving body information FI of the vehicle 20 included in the group GR to be calculated. Next, CPU 61 calculates an average of the acquired speeds of the plurality of vehicles 20 as an average speed AV of the vehicles 20 included in the group GR. Thereafter, CPU 61 advances the process to S43.

In S43, CPU 61 determines whether or not there is an emergency vehicle EV included in the calculation target group GR. Specifically, CPU 61 determines whether or not various kinds of information of the predicted moving body information FI of the vehicle 20 included in the group GR include information indicating that the vehicle is in an emergency vehicle EV. Thereafter, CPU 61 advances the process to S44.

In S44, CPU 61 calculates whether or not there is a large-sized vehicle LV in GR to be calculated. CPU 61 determines whether or not various kinds of information of the predicted moving body information FI of the vehicle 20 included in the group GR include information indicating that the vehicle is a large-sized vehicle LV. Thereafter, CPU 61 advances the process to S45.

In S45, CPU 61 calculates the influence degree IF of the group GR to be calculated. Specifically, CPU 61 calculates the influence degree IF larger as the number of vehicles 20 constituting the group GR to be calculated increases. CPU 61 calculates the influence degree IF to be larger as the average speed AV of the vehicles 20 constituting the calculation target group GR is larger. When the emergency vehicle EV is included in the group GR to be calculated, CPU 61 calculates the influence degree IF larger than when the emergency vehicle EV is not included. When the large-sized vehicle LV is included in the group GR to be calculated, CPU 61 calculates the influence degree IF larger than when the large-sized vehicle LV is not included. Thereafter, CPU 61 adds information indicating the influence degree IF of the group GR to the predicted moving body information FI, and ends the series of processes.

### Control of Traffic Rule Display Device

Next, the control of the traffic rule display device 30 based on the influence degree IF of the group GR performed by the information processing device 60 will be described.

When the first group GR1 and the second group GR2 are located within a vicinity range including a range traveling in accordance with the display of the traffic rule display device 30, CPU 61 starts executing the control program P4 of the traffic rule display device 30. The vicinity range includes a range in which the vehicle travels in accordance with the display of the traffic rule display device 30, and is determined in advance as a range wider than the range. The vicinity range includes, for example, a range of an intersection where the traffic rule display device 30 is provided, and is defined as a range of 100 meters in radius from the center of the intersection.

As illustrated in FIG. 5, when CPU 61 starts executing the control program P4 of the traffic rule display device 30, it first performs S51 process. In S51, CPU 61 determines whether or not the influence degree IF of the first group GR1 is equal to or greater than the influence degree IF of the second group GR2. Specifically, CPU 61 refers to the predicted moving body information FI and acquires the influence degree IF of the first group GR1 and the influence degree IF of the second group GR2. CPU 61 then compares the acquired influence degree IF.

When the influence degree IF of the first group GR1 is equal to or greater than the influence degree IF of the second group GR2 (S51: YES), CPU 61 advances the process to S52. In S52, CPU 61 calculates an indication that allows the first group GR1 to continue traveling. Thereafter, CPU 61 advances the process to S53.

In S53, CPU 61 transmits, to the traffic rule display device 30, a request DM that is a display status enabling the driving of the first group GR1 to be continued. Thereafter, CPU 61 ends the series of processes.

On the other hand, when the influence degree IF of the first group GR1 is less than the influence degree IF of the second group GR2 (S51: NO), CPU 61 advances the process to S61. In S61, CPU 61 calculates a displaying condition in which the traveling of the second group GR2 can be continued. Thereafter, CPU 61 advances the process to S62.

In S62, CPU 61 transmits a control signal to the traffic rule display device 30, the control signal indicating a request DM in which the second-group GR2 can continue traveling. Thereafter, CPU 61 ends the series of processes. In this way, CPU 61 calculates a display state in which the group GR having the higher influence degree IF among the first group GR1 and the second group GR2 can continue traveling, and transmits the request DM that becomes the display state to the traffic rule display device 30.

### Operations of Embodiment

Here, it is assumed that the first group GR1 is traveling on a road traveling in the first direction at an intersection where the traffic rule display device 30 is provided. It is assumed that the second group GR2 is traveling on a road traveling in a second direction intersecting the road traveling in the first direction at an intersection where the traffic rule display device 30 is provided. Then, when the first group GR1 and the second group GR2 are located in the vicinity range including the range in which the vehicle travels according to the display of the traffic rule display device 30, CPU 61 starts executing the control-program P4 of the traffic rule display device 30. The traffic rule display device 30 receives the request DM indicating the state that can continue traveling of the first group GR1 when the influence degree IF of the first group GR1 and the influence degree IF of the second group GR2 is large. In the traffic rule display device 30 that has received the request DM, the control unit 33 controls the display unit 31 to turn on the blue light to the road that travels in the first direction at the installed intersection. In addition, in the traffic rule display device 30, the red lamp is turned on the road traveling in the second direction.

### Effects of Embodiment

(1) According to the above-described embodiment, the servers 40 transmit the request DM for continuing the travel of the first group GR1 to the traffic rule display device 30. Therefore, when the first group GR1 and the second group GR2 travel in range in accordance with the indication of the traffic rule display device 30, the servers 40 can realize that the first group GR1 and the second group GR2 continue to travel in a group GR having a higher influence degree IF. Therefore, with respect to the traffic network in which the plurality of vehicles 20 travel, the servers 40 can prevent the impact on the traffic network from becoming large due to the group GR having a higher influence degree IF being stopped.
(2) According to the above-described embodiment, in the calculation of the influence degree IF, the servers 40 calculate the influence degree IF to be larger as the number NM of the vehicles 20 constituting the group GR increases. Therefore, the servers 40 can easily continue traveling in the group GR of the first group GR1 and the second group GR2 in which NM of vehicles 20 constituting the group GR is large.
(3) According to the above-described embodiment, in the calculation of the influence degree IF, the servers 40 calculate the influence degree IF to be larger as the average speed AV of the vehicles 20 constituting the group GR is larger. Therefore, the servers 40 can easily continue traveling in the group GR of the first group GR1 and the second group GR2 in which the average speed AV of the vehicles 20 constituting the group GR is large.
(4) According to the above-described embodiment, in the calculation of the influence degree IF, the servers 40 calculate the influence degree IF larger than when the emergency vehicle EV is not included in the group GR when the emergency vehicle EV is included. Therefore, it is easy for the servers 40 to continue the traveling of the emergency vehicle EV.
(5) According to the above-described embodiment, in the calculation of the influence degree IF, the servers 40 calculate the influence degree IF larger when the large-sized vehicle LV is included in the group GR than when the large-sized vehicle LV is not included. Therefore, it is easy for the servers 40 to continue the traveling of the large-sized vehicles LV.

### OTHER EMBODIMENTS

The present embodiment can be realized with the following modifications. The present embodiment and the following modifications can be combined with each other within a technically consistent range to be realized.

The method of calculating the influence degree IF is not limited to the embodiment described above. For example, when calculating the influence degree IF, CPU 61 may calculate the influence degree IF of the group GR including the emergency vehicle EV to be larger than the influence degree IF of the group GR not including the emergency vehicle EV. Further, for example, CPU 61 may calculate the influence degree IF to be larger when CPU 61 calculates the influence degree IF as the mean of the sizes of the vehicles 20 constituting the group GR is larger. That is, CPU 61 may calculate the influence degree IF regardless of a part or all of the number NM of the vehicle 20, the average speed AV of the vehicle 20, the presence or absence of the emergency vehicle EV, and the presence or absence of the large-sized vehicle LV.

The method of determining the group GR is not limited to the exemplary embodiment described above. For example, CPU 61 may omit S21 process and identify the group GR by S22 process. Further, CPU 61 may omit S22 process and identify the plurality of vehicles 20 extracted by S21 process as the group GR. Further, for example, when information indicating the destination of the vehicle 20 is included in the moving body information VI in addition to or in place of S21 and S22 processes, CPU 61 may identify the group GR based on the information indicating the destination. Specifically, CPU 61 may identify, as the group GR, the vehicles 20 having the same destination as the destination.

The method of generating the predicted moving body information FI is not limited to the embodiment described above. For example, the reference time may be set as a time that is later than the acquisition point in time of all the vehicles 20. Even in this situation, CPU 61 can generate the predicted moving body information FI after acquiring the moving body information VI.

The moving body information VI is not limited to information acquired from the vehicles 20. For example, the moving body information VI may be information obtained by the servers 40 from the cameras on the information about the vehicles 20 obtained by the cameras provided in the traffic network.

The configuration of the display unit 31 of the traffic rule display device 30 is not limited to the example of the above-described embodiment. For example, in addition to the red lamp and the blue lamp, a lamp that permits traveling in each direction of travel of the intersection may be included.

The traffic rule display device 30 is not limited to a traffic signal. For example, it may be an electric bulletin board that displays traffic rules, or it may be a plurality of road tacks. The traffic rule display device 30 may be any device that displays different traffic rules by changing the display state.

The display state in which the first group GR1 can continue traveling in the traffic rule display device 30 is not necessarily a display state in which the second group GR2 cannot continue traveling. As in the above-described embodiment, the server 40 causes the first group GR1 to be in a displayed state in which the travel can be continued when the first group GR1 or the second group GR2 is in a state in which the travel can be continued. At the same time, the driving of the second group GR2 may not be continued.

The servers 40 may determine whether or not to execute S53 and S62 processes by referring to the display status of the traffic rule display device 30 of the predicted moving body information FI. For example, when S53 process is executed, S53 process may be executed only when the display state of the traffic rule display device 30 in the predicted moving body information FI is not a display state in which the traveling of the first group GR1 can be continued.

The information processing device 60 may be configured as a circuitry including one or more processors that execute various processes in accordance with a computer program (software). Note that the information processing device 60 may be configured as a circuit including one or more dedicated hardware circuits such as an application-specific integrated circuit (ASIC) that executes at least some of the various processes, or a combination thereof. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer.

What is claimed is:

1. A server that transmits a control signal based on predicted moving body information, that is generated based on moving body information that is information of a vehicle in a real world, following a point in time of acquiring the moving body information, to a traffic rule display device that displays different traffic rules by changing a display state, the server executing
identifying a first group, and a second group different from the first group, as groups in which a plurality of the vehicles travels in a group, based on the predicted moving body information,
calculating, for each of the groups identified, an influence degree, indicating a degree of influence imparted on a traffic network when the group that is an object of calculation is stopped,
calculating, when the first group and the second group are located within a vicinity range including a range of traveling in accordance with a display of the traffic rule display device, the display state under which the group of the first group and the second group of which the influence degree is higher can continue traveling, and
transmitting a request, that is the display state that is calculated, to the traffic rule display device.

2. The server according to claim 1, wherein, when calculating the influence degree, the greater a count of the vehicles making up the group that is the object of calculation is, the greater the influence degree is calculated to be.

3. The server according to claim 1, wherein, when calculating the influence degree, the higher an average speed of the vehicles making up the group that is the object of calculation is, the greater the influence degree is calculated to be.

4. The server according to claim 1, wherein, when calculating the influence degree, the influence degree is calculated to be greater when the group that is the object of calculation includes an emergency vehicle, than when not including the emergency vehicle.

5. The server according to claim 1, wherein, when calculating the influence degree, the influence degree is calculated to be greater when the group that is the object of calculation includes a large-sized vehicle, than when not including the large-sized vehicle.
